(19) United States
(12) Patent Application Publication
(10) Pub. No.: US 2017/0234419 A1
(43) Pub. Date: Aug. 17, 2017

(54) TORSIONAL VIBRATION DAMPERS

(71) Applicant: Suhale Manzoor, Plymouth, MI (US)

(72) Inventor: Suhale Manzoor, Plymouth, MI (US)

(73) Assignee: Dayco IP Holdings, LLC, Troy, MI (US)

(21) Appl. No.: 15/429,611

(22) Filed: Feb. 10, 2017

Related U.S. Application Data
(60) Provisional application No. 62/295,021, filed on Feb. 13, 2016.

(51) Int. Cl. F16H 55/36; F02B 67/06; F16F 15/121

(52) U.S. Cl. CPC F16H 55/36; F16F 15/1216; F02B 67/06; F16F 2238/024; F16H 2055/366

(57) ABSTRACT

Torsional vibration dampers having a dual spring-dashpot system are disclosed that result in a lightweight hub and a lightweight inertia ring, which is concentric about the hub. The hub has a two-piece construction: a central hub defining an innermost sleeve that defines a bore for receiving a shaft; and a monolithic, generally-annular spoke defining an outermost ring concentric about and spaced radially outward from the central hub portion. A first elastomer member, which acts as a primary spring to damp torsional vibrations, is positioned concentrically against an inner surface or an outer surface of the outermost ring of the hub with the inertia ring concentrically positioned against the first elastomer member. A second elastomer member is positioned between and operatively couples the central hub to the annular spoke, thereby attributing a flexibility to the hub.

### RELATED APPLICATIONS

This application claims the benefit of U.S. Provisional Application No. 62/295,021, filed Feb. 13, 2016, which is incorporated by reference herein in its entirety.

### FIELD OF THE INVENTION

The present invention relates to torsional vibration dampers, more particularly torsional vibrations dampers having a reduced mass for a spoke portion of a hub that is operatively coupled to a central hub by a secondary elastomer spring and a reduced mass for an inertia ring, which is operatively coupled to the spoke portion by a primary elastomer spring, thereby forming a dual dashpot system.

### BACKGROUND OF THE INVENTION

Torsional vibration dampers (“TVDs”) are employed extensively in internal combustion engines to reduce torsional vibrations delivered to rotatable shafts. The torsional vibrations may be of considerable amplitude, and, if not abated, can potentially damage gears or similar structures attached to the rotatable shaft and cause fatigue failure of the rotatable shaft.

Torsional vibration dampers convert the kinetic vibrational energy by dissipating it to thermal energy as a result of damping. The absorption of the vibrational energy lowers the strength requirements of the rotatable shaft and thereby lowers the required weight of the shaft. The torsional vibration damper also has a direct effect on inhibiting vibration of nearby components of the internal combustion engine that would be affected by the vibration.

The simplest insertion style torsional vibration damper has three components, a hub that allows the damper to be rigidly connected to the source of the vibration, an inertia ring, and an elastomer member between the hub and the inertia ring. The elastomer member provides the spring dashpot system for the damper. The hub and the inertia ring are manufactured individually and machined before the elastomer is inserted by force into the gap that is present between the hub and the inertia ring. The elastomer is compressed and exerts pressure between the metallic surfaces of the inertia ring and hub, holding the assembly together.

For any mechanical system, the torsional natural frequency depends upon the inertia, torsional stiffness and damping of the system. In the traditional torsional vibration damper, the inertia is provided by the inertia ring, while the damping and torsional stiffness are provided by the elastomer member. This otherwise implies that the hub is, in fact, a rigid attachment that does not provide any significant help to the damping system except to provide a rigid means of connection to the rotating component of the vehicle. Thus, the damping in these traditional torsional vibration dampers, by definition, is fully a result of the elastomer member.

Weight reduction is desirable for torsional vibration dampers, as well as, reducing the cost. The traditional way of achieving weight reduction has been to switch the hub from cast iron to a stamped or spun steel or a cast or forged aluminum construction. Attempts have been made to use a phenolic material for the hub of a TVD, but none have resulted in a commercially suitable TVD because this material lacks the fatigue strength required to function as a hub.

Accordingly, new torsional vibration dampers that accomplish weight reduction and/or incorporation of a phenolic or other lower weight material are desired.

### SUMMARY

Torsional vibration dampers having a dual spring-dashpot system are disclosed herein that result in a lightweight hub and a lightweight inertia ring. Surprisingly, not only can the mass of the spoke portion of the hub be reduced, but so can the mass of the inertia ring due to the presence of a secondary elastomer spring that contributes flexibility to the hub. The mass of the spoke portion may be reduced by using phenolic material or non-metallic composite material for its construction.

In all aspects, the torsional vibration dampers have a hub with a two-piece construction: a central hub defining an innermost sleeve that defines a bore for receiving a shaft, and a monolithic, generally-annular spoke defining an outermost ring concentric about and spaced radially outward from the central hub portion. A first elastomer member, which acts as the primary spring of the dual spring-dashpot system (to damp torsional vibrations), is positioned concentrically against an inner surface or an outer surface of the outermost ring of the annular spoke with the inertia ring concentrically positioned against the first elastomer member. A second elastomer member is positioned between and operatively couples the central hub to the annular spoke.

In all embodiments, the second elastomer member may be positioned concentrically or axially between a first surface of the central hub and a second surface of the monolithic, generally-annular spoke. The monolithic, generally-annular spoke is constructed of one or more of a phenolic material, a glass-filled nylon, and die cast aluminum.

In all embodiments, the inertia ring has a polar moment of inertia of about 1000 kg-mm² to about 40,000 kg-mm², and the dual spring-dashpot system increases the reaction torque of the inertia ring, as a harmonic response reaction moment at unit torque input at the outer diameter of the inertia ring, by at least a factor of 1.5 at its peak.

In some aspects, the monolithic, generally-annular spoke comprises a single, continuous annular spoke joining the outermost ring to an intermediate ring of the monolithic, generally-annular spoke. This single, continuous annular spoke may be generally, axially centered between the outermost ring and the intermediate ring and have an axial thickness of about 3 mm to about 20 mm.

In some aspects, the outermost ring of the monolithic, generally-annular spoke is the outermost surface of the torsional vibration damper and the inertia ring is positioned radially inward thereof concentric to the inner surface of the outermost ring of the hub. The outermost ring may define a belt-engaging surface.

In one embodiment, the inertia ring defines the outermost surface of the torsional vibration damper, and this surface may define a belt-engaging surface.

In one embodiment, the second elastomer member is positioned axially between the central hub and the monolithic, generally-annular spoke and is mold bonded thereto, and either the inertia ring or the outermost ring of the monolithic, generally-annular spoke defines the outermost surface of the torsional vibration damper.

In some embodiments, the first elastomer member is seated in an annular recess in a surface of the outermost ring of the hub, in an annular recess in a surface of the inertia ring, or in an annular recess in each thereof. Preferably, the annular recesses are concentric about the axis of rotation. In one embodiment, both the outermost ring of the hub and the inertia ring have the annular recess and one of the annular recesses is deeper than the other.

In some embodiments, the first elastomer member has a first axial width that is substantially similar to a second axial width of the outermost ring of the hub, and is press-fit between the hub and the inertia ring or is mold bonded to one of the hub or inertia ring.

In some embodiments, the first elastomer member comprises a plurality of first elastomer members each having a first axial width that is less than a second axial width of the outermost ring of the monolithic, generally-annular spoke and are positioned a distance apart in an axial direction from one another.

In another aspect, front end accessory drive systems are contemplated that include any one of the torsional vibration dampers disclosed herein.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a perspective view of components in a front end accessory drive.

FIG. 2 is a perspective view, in a partial longitudinal cross-section, of one embodiment of a torsional vibration damper having a dual spring-dashpot system.

FIG. 3 is a partial, longitudinal, cross-sectional view of another embodiment of a torsional vibration damper having a dual spring-dashpot system.

FIG. 4 is a partial, longitudinal, cross-sectional view of a third embodiment of a torsional vibration damper having a dual spring-dashpot system.

FIG. 5 is a partial, longitudinal, cross-sectional view of a fourth embodiment of a torsional vibration damper having a dual spring-dashpot system.

FIGS. 6A and 6B are comparative finite element analysis models of the first mode and second mode of a prior art single spring-dashpot system compared to a dual spring-dashpot system illustrated in FIG. 2.

FIG. 7 is a comparison of finite element analysis maximum principle stress plots normalized to 27.4 MPa of a prior art monolithic hub (top) and a two-piece hub (bottom) as illustrated in FIG. 2.

FIG. 8 is a graph of the harmonic response reaction moment at the fixed bore joint of a prior art rigid hub compared to the flexible two-piece hub illustrated in FIG. 2.

FIGS. 9-16 are each a partial transverse cross-sectional view of a variation in the first elastomer member assembly.

### DETAILED DESCRIPTION

The following detailed description will illustrate the general principles of the invention, examples of which are additionally illustrated in the accompanying drawings. In the drawings, like reference numbers indicate identical or functionally similar elements.

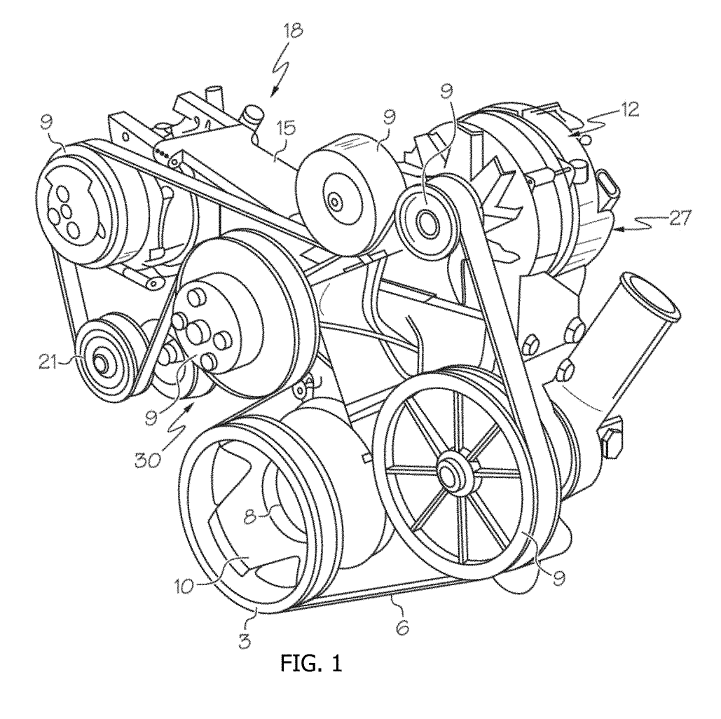

Referring now to FIG. 1, an example of one embodiment of an FEAD system 18 is shown, merely for illustration purposes, that includes an integrated housing 15, having a front surface 30 and a rear surface 27. The rear surface 27 of the integrated housing 15 is preferably mounted to an engine. The FEAD system 18 may be utilized with any engine, including vehicle, marine and stationary engines. The shape and configuration of the integrated housing 15 depends upon the vehicle engine to which it is to be mounted. Accordingly, the integrated housing 15, and more specifically the FEAD system 18, may vary along with the location of engine drive accessories 9, including idler pulleys. It should be understood that the location and number of engine drive accessories 9 may be varied. For example, a vacuum pump, a fuel injection pump, an oil pump, a water pump, a power steering pump, an air conditioning pump, and a cam drive are examples of other engine drive accessories 9 that may be mounted on the integrated housing 15, for incorporation into the FEAD system 18. The engine drive accessories 9 are preferably mounted to the integrated housing 15 by bolts or the like at locations along the surface that are tool accessible for easy mounting and also service accessible. In FIG. 1, the integrated housing 15 has a plurality of engine drive accessories 9, including an alternator 12 and a belt tensioner 21.

The engine drive accessories 9 are driven by at least one endless drive belt 6, which may be a flat belt, a rounded belt, a V-belt, a multi-groove belt, a ribbed belt, etc., or a combination of the aforementioned belts, being single or double sided. The endless drive belt 6 may be a serpentine belt. The endless drive belt 6 may be wound around the engine drive accessories 9, the alternator 12, the belt tensioner 21, and the drive pulley 3, which is connected to the nose 10 of the crankshaft 8. The crankshaft drives the drive pulley 3 and thereby drives the endless drive belt 6, which in turn drives the remaining engine drive accessories 9 and the alternator 12.

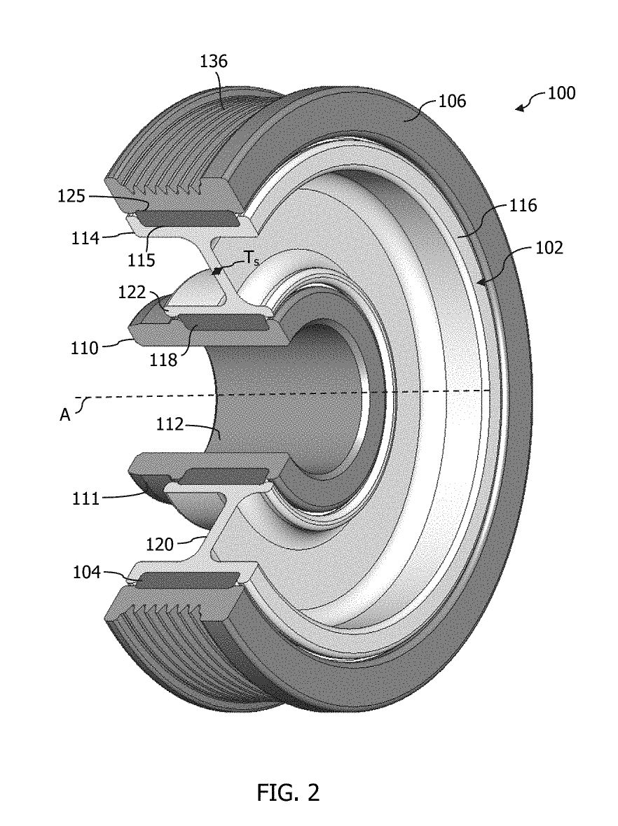

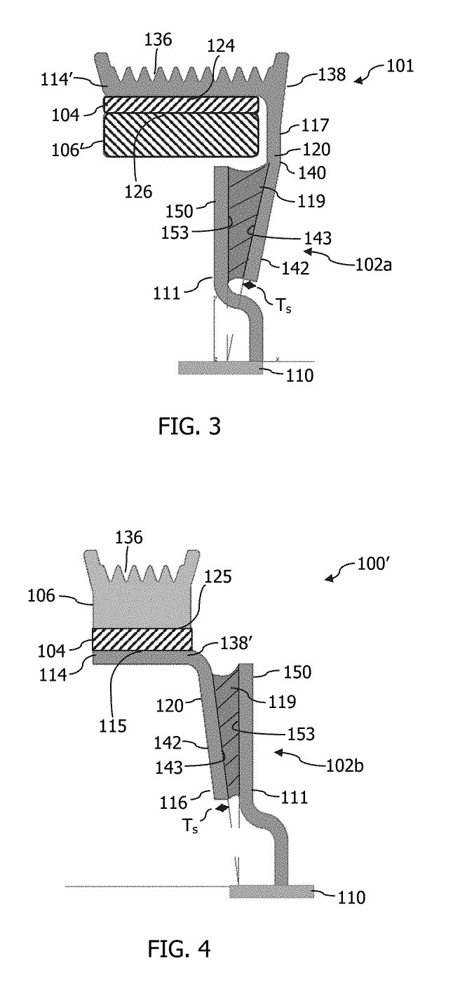

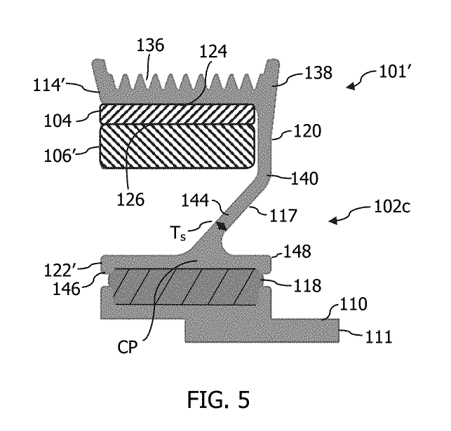

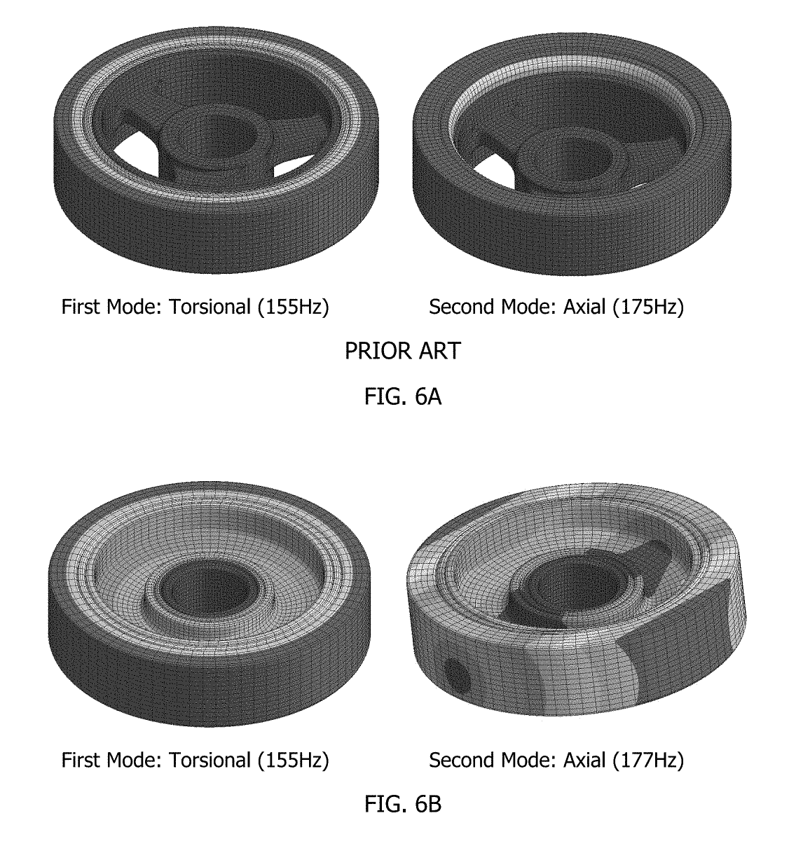

Referring now to FIGS. 2-5, the improvement to the FEAD system 18 is a torsional vibration damper, generally designated by reference 100 in FIG. 2, 101 in FIG. 3, 100′ in FIGS. 4, and 101′ in FIG. 5, that has a dual spring-dashpot system that enables the TVD to have a reduced mass, not only by reducing the mass of the hub 102, 102a, 102b, 102c, but unexpectedly the mass of the inertia ring 106, 106′. Each hub 102, 102a-c defines an axis of rotation A, has an innermost sleeve 110 defining a bore 112 for receiving a shaft (not shown), and has an outermost ring 114, 114′ concentric about the axis of rotation A and spaced radially outward from the innermost sleeve 110. The shaft may be a crankshaft of an engine. An inertia ring 106, 106′ is positioned concentrically against a first elastomer member 104, which is positioned against a surface of the outermost ring 114, 114′ of the hub 102, 102a-c, thereby operably coupling the inertia ring 106, 106′ to the hub for rotation together. With reference to FIGS. 2 and 4, the first elastomer member 104 is positioned concentrically against an outer surface 115 of the outermost ring 114 of the hub 102 and against an inner surface 125 of the inertia member 106. With reference to FIGS. 3 and 5, the first elastomer member 104 is positioned concentrically about the axis of rotation A against an inner surface 124 of the outermost ring 114′ of the hub 102 and against an outer surface 126 of the inertia ring 106′. This first elastomer member 104 is the primary spring utilized to tune the TVD to provide a desired amount of damping.

The inertia ring 106, 106′ may be made from any material having a sufficient inertia, usually cast iron, steel, or similar dense material, formed by a variety of methods. The inertia ring 106, 106′ can be extruded, cast, cast and subsequently machined, shell molded, or completely machined, just to name a few non-limiting examples.

The hubs 102, 102a, 102b, and 102c each comprise a two-piece construction: a central hub portion 111 defining the innermost sleeve 110; and a monolithic, generally-annular spoke portion 116 (FIGS. 2 and 4), 117 (FIGS. 3 and 5) defining the outermost ring 114, 114′ of the respective hubs. In FIGS. 2 and 4, the inertia ring 106 is the outermost component of the torsional vibration damper 100, 100′, but in FIGS. 3 and 5 the outermost ring 114′ of the hub 102a, 102c is the outermost component of the torsional vibration damper 101, 101′. Whichever component is the outermost component of the TVD may include a belt-engaging surface 136. The belt engaging surface 136 is an outer annular surface that is radially outward relative to the axis of rotation A of the TVD, which may be flat, contoured to receive a rounded belt, or have V-grooves for mating with the V-ribs of a V-ribbed belt, or have any other required contoured groove to mate with an endless belt.

The central hub portion 111 is typically made from any metal(s) suitable for torsional vibration dampers, including, but not limited to steel, ductile iron, grey iron and aluminum, and can be extruded, cast, cast and subsequently machined, shell molded, or completely machined, just to name a few non-limiting examples. In FIGS. 2 and 4, the central hub portion 111 is shown as operatively coupled to the spoke portion 116 by a second elastomer member 118 positioned concentrically therebetween. In FIGS. 3 and 5, the central hub portion 111 is shown operatively coupled to the spoke portion 117 by a second elastomer member 119 positioned axially therebetween. The presence of the second elastomer member 118, 119 forms a dual spring-dashpot system for the TVDs where the spoke portion 116, 117 floats between the two elastomer members 104 and 118 or 119, and contributes flexibility to the hub 102, 102a-c.

The benefits of these TVD constructions are two-fold. First, the TVDs 100, 100′, 101, and 101′ can be constructed with lighter material for the spoke portion 116, 117, such as, but not limited to, phenolic materials, glass-filled nylons, or die cast aluminum, including A380 aluminum alloy. Example phenolic materials are available from Akolite Synthetic Resins of India. Glass filled nylons having 40% to 85% by weight glass filler are suitable, more preferably 55% to 70% by weight glass filler. Examples of glass-filled nylons include those available from Dupont under the brand name ZYTEL™. Second, the TVDs 100, 100′, 101, and 101′ can be constructed with a reduced mass inertia ring 106, 106′. The dual spring-dashpot system allows the inertia ring 106, 106′ to oscillate at greater angular amplitude, thereby enabling a lower polar moment of inertia for the inertia ring 106, 106′ as compared to single spring-dashpot TVDs. The result of being able to reduce the mass of the inertia ring for comparable results to prior art TVDs was surprising. In most automotive applications, the inertia ring 106, 106′ has a polar mass moment of inertia of about 1000 kg-mm² to about 40,000 kg-mm², more preferably 5000 kg-mm² to about 30,000 kg-mm².

In each embodiment of FIGS. 2-5, the spoke portion 116, 117 comprises a single, continuous annular spoke 120 extending from the outermost ring 114, 114′ generally toward the axis of rotation A and the central hub portion 111.

With reference to just FIG. 2, the single, continuous annular spoke 120 extends from the outermost ring 114 and between the outermost ring 114 and an intermediate ring 122 of the hub 102. The continuous annular spoke 120 is generally, axially centered between the outermost ring 114 and the intermediate ring 122, and, as such, is generally I-shaped when viewed in a longitudinal cross-section. Since the spoke portion 116 floats between the first and second elastomer members 104, 118, part of the reduction of its mass is from the ability to make the spoke 120 thin compared to prior art TVDs.

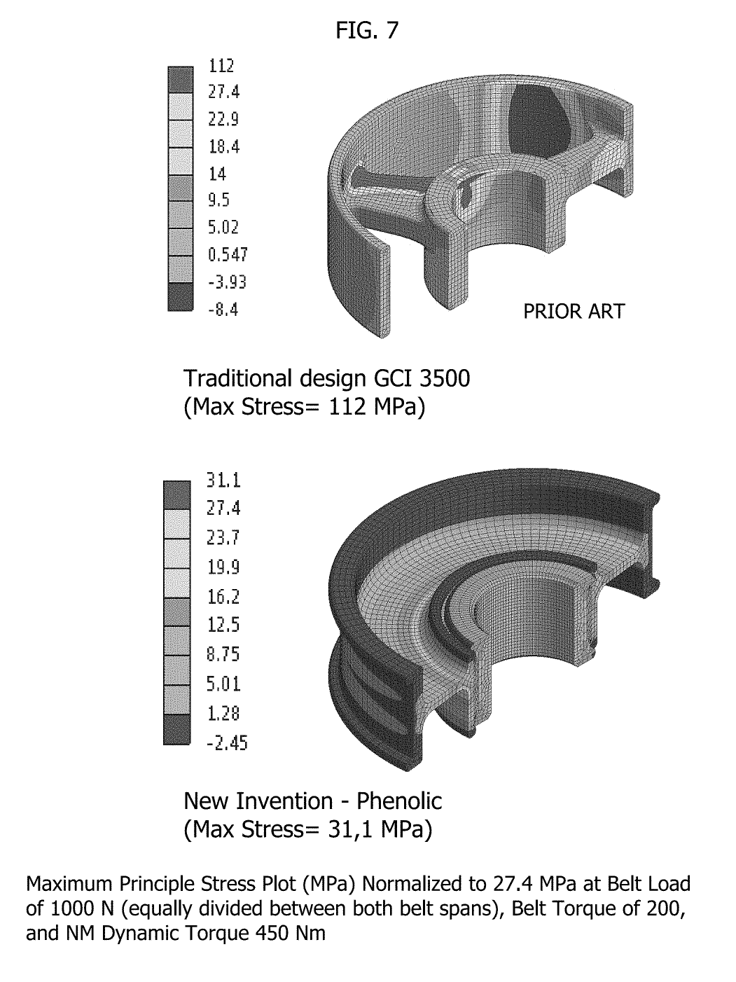

As shown by the finite element analysis models in FIGS. 6A and 6B, the dual spring-dashpot TVD 100 of FIG. 2 has the same torsional mode, frequency 155 Hz, as a prior art single spring-dashpot system and has a second mode that has a comparable frequency, 177 Hz compared to 175 Hz. This demonstrates that the TVD 100 will perform as well as the prior art TVD, but with an overall reduced mass, as discussed above.

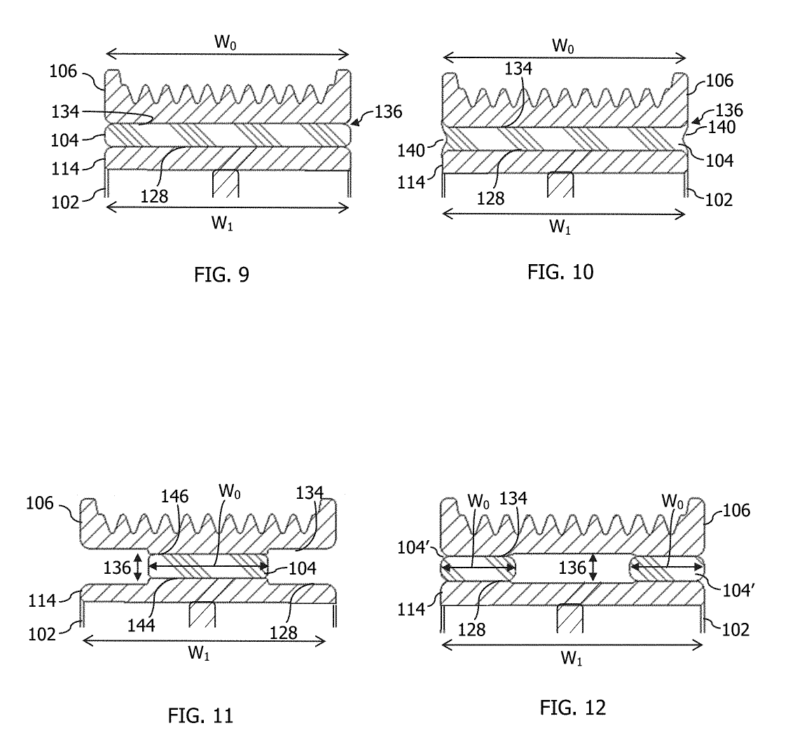

Referring now to FIG. 8, the dual spring-dashpot system of TVD 100 of FIG. 2 was compared to a rigid hub coupled to an inertia member by a single spring-dashpot system. Each TVD has the same peak frequency (about 155 Hz) as seen in the graph of the Harmonic Response Reaction Moment. The data was gathered under a 1 Nm applied force at the outer diameter of the inertia ring over a frequency range from about 100 Hz to about 200 Hz. As seen in the graph, the reaction torque of the inertia ring 106 of TVD 100 is greater than the single dashpot system by at least a factor of 1.5 at the peak frequency.

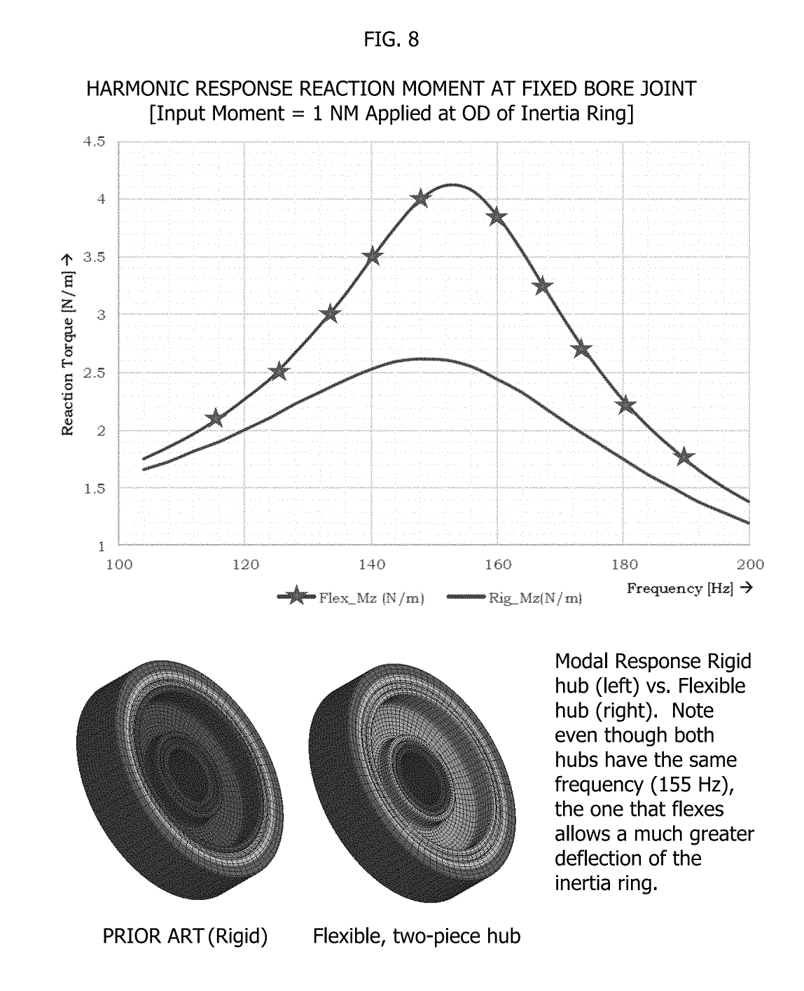

Further, the dual spring-dashpot TVD 100 of FIG. 2 was tested for its stress response to compare the performance with its single, continuous spoke 120 to a plurality of spokes in a rigid, monolithic hub as seen in FIG. 7. The stress response was greatly enhanced as seen by the finite element analysis models where the maximum principle stress plot in MPa is normalized to 27.4 MPa at a belt load of 1000 N (equally divided between both belt spans), with a belt torque of 200 Nm and a dynamic torque of 450 Nm.

With reference to FIG. 3, the single, continuous annular spoke 120 extends from a first axial end 138 of the outermost ring 114′, which is the outermost component of the TVD 102a, relative to the axis of rotation. The continuous annular spoke 120 may include a bend 140 permanently angling a second elastomer-receiving portion 142 of the continuous annular spoke toward the surface of the central hub portion 111 to which the second elastomer member 119 is mold bonded. Accordingly, the second elastomer member 119 is mold bonded between the second elastomer-receiving portion 142 of the continuous annular spoke 120 and the second-elastomer-receiving portion 150 of the central hub portion 111. As illustrated, both the second elastomer-receiving portions 142, 150 terminate without flanges.

As represented in FIG. 3, the opposing faces 143, 153 of the second elastomer-receiving portions 142, 150, respectively, to which the second elastomer 119 is mold bonded, include at least the face 143 of the second elastomer-receiving portion of the continuous annular spoke 120 being angled such that a line coextensive with the face 143 and a second line coextensive with the opposing face 153, each extending radially inward will meet at the axis of rotation, thereby defining a vertex. This construction defines a smaller gap for the second elastomeric member 119 more proximate the axis of rotation A than more distal the axis of rotation A, and the gap widens gradually moving radially outward away from the axis of rotation A, which keeps the second elastomeric member 119 in a state of uniform shear strain during oscillation of the inertia member 106′ with respect to the hub 102. Alternately, both of the opposing faces 143, 153 may be angled toward one another to define the vertex, or just the face 153 of the second elastomer-receiving portion 150 of the central hub portion 111 may be angled toward the second elastomer-receiving portions 142 of the continuous spoke portion 117 (for at least the portion seated against the second elastomer member). Accordingly, multi-variations are possible for defining the gap in which the second elastomer member is mold bonded, but the result is always a second elastomer member having a generally trapezoidal longitudinal cross-section relative to the axis of rotation in an assembled state.

With reference to FIG. 4, the single, continuous annular spoke 120 extends from a first axial end 138′ of the outermost ring 114 in a direction generally radially inward toward the axis of rotation. The face 143 (to which the second elastomer 119 is mold bonded) of a second elastomer-receiving portion 142 of the annular spoke 120 is angled, such that a line coextensive with the face 143 and a second line coextensive with an opposing face 153 of the central hub portion 111 (to which the second elastomer member 119 is also mold bonded) each extend radially inward and meet at the axis of rotation to define a vertex. This construction defines a smaller gap for the second elastomer member 119 more proximate the axis of rotation A than more distal the axis of rotation A, and the gap widens gradually moving radially outward away from the axis of rotation A, which keeps the second elastomer member 119 in a state of uniform shear strain during oscillation of the inertia member 106 with respect to the hub 102. Alternately, both of opposing faces 143, 153 may be angled toward one another to define the vertex, or just the face 153 of the second elastomer-receiving portion 150 of the central hub portion 111 may be angled toward the second elastomer-receiving portions 142 of the continuous spoke portion 116 (for at least the portion seated against the second elastomer member). Accordingly, multi-variations are possible for defining the gap in which the second elastomer member is mold bonded, but the result is always a second elastomer member having a generally trapezoidal longitudinal cross-section relative to the axis of rotation in an assembled state.

With reference to FIG. 5, the monolithic, generally-annular spoke portion 117 of the hub 102 includes a single, continuous annular spoke 120 extending from a first axial end 138 of the outermost ring 114′ thereof, which is the outermost component of the TVD 102c. The single, continuous annular spoke 120 extends toward the axis of rotation and may include a bend 140 permanently angling a more axially proximate portion 144 thereof toward an intermediate ring 122′ of the monolithic, generally-annular spoke portion 117 so that the continuous annular spoke has a junction with the intermediate ring 122′ more proximate an axial center-point CP thereof than an axial end 146, 148 thereof. Here, the first and second elastomer members 104, 118 are preferably press-fit into the gaps between the monolithic, generally-annular spoke portion 117 and the inertia member and the central hub portion. As such, no mold bonding is required and an adhesive is optional.

In all the embodiments, since the monolithic, generally-annular spoke portion 116, 117 floats between the first and second elastomer members 104, 118 or 119, part of the reduction of the mass is from the ability to make the continuous annular spoke 120 thin compared to prior art TVDs. The continuous annular spoke 120 may have an axial thickness Tₛ of about 3 mm to about 20 mm, more preferably about 4 mm to about 12 mm.

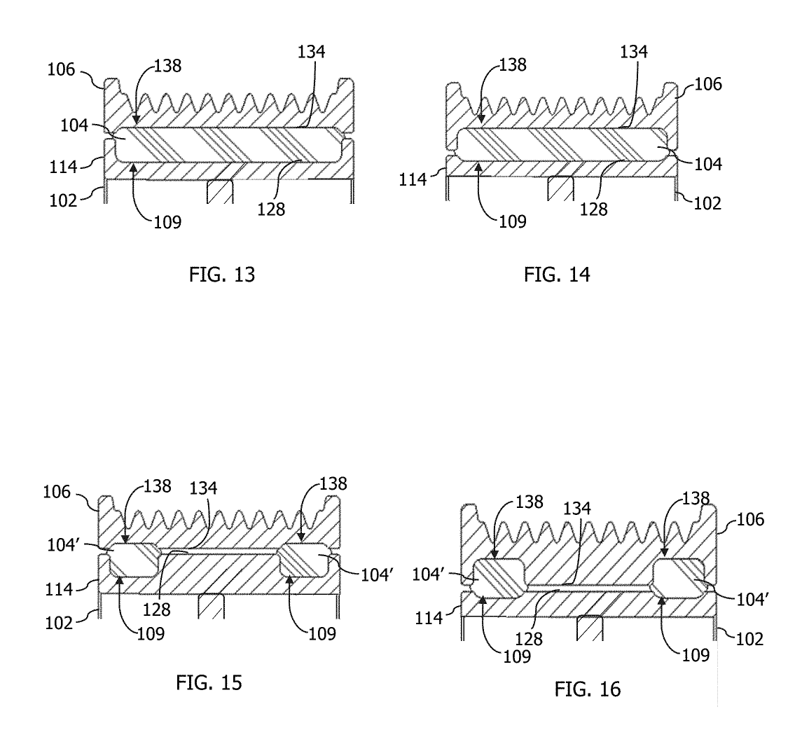

The first elastomer member 104 may take a variety of forms, including a single annular ring or discrete dual annular rings seated on or recessed into at least one of the inertia ring 106, 106′ or the outermost ring 114, 114′ of the hub 102, 102a-c as shown and described in more detail below with respect to FIGS. 9-16. While each of the variations for the first elastomer member 104 is disclosed with respect to the inertia ring 106 as the outermost component of the TVD, it is understood that the positions can be reversed as shown in FIGS. 3 and 5. Referring now to FIG. 9, a single first elastomer member 104 is positioned in the gap between the outermost ring 114 of the hub 102 and the inertia ring 106, and the first elastomer member 104 may have a width W₀ that is substantially similar to a width W₁ of the surface 128 of the outermost ring 114 upon which the first elastomer member 104 is seated. In the embodiment shown in FIG. 9, the first elastomer member 104 is inserted between the hub 102 and the inertia ring 106, such as by press-fitting or the like, or is post-bonded to the hub 102 and/or the inertia ring 106. FIG. 10 shows the first elastomer member 104 having width W₀ substantially the same as the width W₁ of the surface 128 of the hub 102 or the radial inner surface 134 of the inertia ring 106; however, the first elastomer member 104 is molded into the gap 136 between the hub 102 and the inertia ring 106, and as a result axial shrinkage occurs at the axially outermost surfaces 140 of the first elastomer member 104 resulting in the concave axial edges of the first elastomer member 104.

Referring to FIG. 11, the first elastomer member 104 may be a single elastomer member having a width W₀ that is less than the width W₁ of the radial outermost surface 128 of the outermost ring 114 of the hub 102 or the radial inner surface 134 of the inertia ring 106. The radial outermost surface 128 of the hub 102 may have an outer engaging portion 144 protruding radially outward therefrom upon which the elastomer member 104 is seated. The radial inner surface 134 of the inertia ring 106, likewise or as an alternative to the radial outermost surface 128, may have an inner engaging portion 146 protruding radially inward from the radial inner surface 134 upon which an opposing side of the elastomer member 104 is seated in compression to operatively couple the inertia ring 106 to the hub 102 for rotation together.

Referring to FIG. 12, the torsional vibration damper 100 may include a plurality of first elastomer members 104, 104′ positioned in the gap 136 between the hub 102 and the inertia ring 106. Each of the elastomer members 104, 104′ has a width W₀ that is less than the width W₁ of the radial outermost surface 128 of the hub 102 or the radial inner surface 134 of the inertia ring 106. Although FIG. 10 shows two elastomer members 104, 104′, it is understood that more than two elastomer members may be utilized. The elastomer members 104, 104′ may be annular and may be spaced a distance apart in an axial direction from one another or may abut against an immediately neighboring elastomer member. The elastomer members may also be a plurality of discrete pieces, which may be spaced apart, evenly or otherwise, in either or both of the axial and angular directions.

Referring now to FIGS. 13-16, embodiments are illustrated that include the radial outermost surface 128 of the outermost ring 114 of the hub 102 defining one or more recesses 109 and the radial inner surface 134 of the inertia ring 106 defining one or more mirror image recesses 138 facing one another. FIGS. 13-14 illustrate a single first elastomer member 104 positioned with a portion of the first elastomer member 104 seated in the recess 109 and another portion of the elastomer member 104 seated in the mirror image recess 138. In FIG. 13, the recess 109 in the hub 102 is deeper than the mirror image recess 138 in the inertia member 106, so that a larger portion of the elastomer member 104 is seated within the recess 109 of the hub 102. In FIG. 14, the mirror image recess 138 in the inertia ring 106 is deeper than recess 109, resulting in a larger portion of the elastomer member 104 being seated within the mirror image recess 138.

FIGS. 15-16 illustrate embodiments similar to those depicted in FIGS. 13-14, except with a plurality of first elastomer members 104′ seated between the hub 102 and the inertia ring 106, with both of the elastomer members 104′ seated in the respective recesses 109, 138. Although only two elastomer members are shown, it is understood that more than two elastomer members may be utilized. In FIG. 15, the recesses 109 in the hub 102 are deeper than the mirror image recesses 138 in the inertia ring 106. In FIG. 16, the mirror image recesses 138 are deeper than the recesses 109 of the hub 102, resulting in a larger portion of each of the first elastomer members 104′ being seated within the mirror image recesses 138.

The first elastomer member(s) 104, 104′ may be any elastomer material suitable to absorb and/or damp torsional vibrations, as the case may be, generated by a rotating shaft upon which the torsional vibration damper is mounted. The elastomer members can be formed by extrusion compression, transfer or injection molding. The elastomer material is preferably one suitable for automotive engine applications, i.e., suitable to withstand temperatures experienced in the engine and road temperatures and conditions. The elastomer material may be as disclosed in U.S. Pat. No. 7,658,127, which is incorporated herein, in its entirety, by reference. In one embodiment, the elastomer members may be made from or include one or more of a styrene-butadiene rubber, a natural rubber, a nitrile butadiene rubber, an ethylene propylene diene rubber (EPDM), an ethylene acrylic elastomer, a hydrogenated nitrile butadiene rubber, and a polycholoroprene rubber. One example of an ethylene acrylic elastomer is VAMAC® ethylene acrylic elastomer from E. I. du Pont de Nemours and Company. The elastomer member may be a composite material that optionally includes a plurality of fibers dispersed therein. The fibers may be continuous or fragmented (chopped) aramid fiber like the fiber sold under the name TECHNORA® fiber. In one embodiment, the elastomer damper member may be attached to the hub 102, 102a-c and/or the inertia ring 106, 106′ using a conventional adhesive known for use in vibration damping systems. Some examples of suitable adhesives include rubber bonding adhesives sold by the Lord Corporation, Henkel AG & Co., or Morton International Incorporated Adhesives & Specialty Company.

Also, for any TVD where the second elastomer member 118 is also concentrically positioned between annular axially oriented surfaces of the central hub portion 110 and the intermediate ring 122, 122′ of the monolithic, generally-annular spoke portion 116, 117, FIGS. 2 and 5, the second elastomer member 118 may have any of the configurations described above for the first elastomer member 104 and the central hub portion 110 and the intermediate ring 122, 122′ can have any of the recess or protruding engaging portions described above with respect to the inertia ring and the monolithic, generally-annular spoke portion 116, 117.

It will be appreciated that while the invention has been described in detail and with reference to specific embodiments, numerous modifications and variations are possible without departing from the spirit and scope of the invention as defined by the following claims.

What is claimed is:

1. A torsional vibration damper comprising:
a two-piece hub defining an axis of rotation and comprising:
a central hub having an innermost sleeve defining a bore for receiving a shaft, and
a monolithic, generally-annular spoke having an outermost ring concentric about the axis of rotation and spaced radially outward from the innermost sleeve;
a first elastomer member positioned concentrically against either an inner surface or an outer surface of the outermost ring of the monolithic, generally-annular spoke, wherein the first elastomer member acts as a primary spring to damp torsional vibrations;
an inertia ring positioned concentrically and operatively coupled against the first elastomer member for rotation together; and
a second elastomer member positioned between and operatively coupling the central hub and the monolithic, generally-annular spoke for rotation together, wherein the second elastomer member contributes flexibility to the hub;
wherein the first elastomer member and the second elastomer member form a dual spring-dashpot system.

2. The torsional vibration damper of claim 1, wherein the second elastomer member is positioned concentrically or axially between a first surface of the central hub and a second surface of the monolithic, generally-annular spoke.

3. The torsional vibration damper of claim 1, wherein the monolithic, generally-annular spoke comprises one or more of a phenolic material, a glass-filled nylon, and die cast aluminum.

4. The torsional vibration damper of claim 1, wherein the inertia ring has a polar moment of inertia of about 1000 kg-mm² to about 40,000 kg-mm².

5. The torsional vibration damper of claim 1, wherein the dual spring-dashpot system increases the reaction torque of the inertia ring, as a harmonic response reaction moment at unit torque input at the outer diameter of the inertia ring, by at least a factor of 1.5 at its peak.

6. The torsional vibration damper of claim 1, wherein the monolithic, generally-annular spoke comprises a single, continuous annular spoke joining the outermost ring of the hub to an intermediate ring of the hub.

7. The torsional vibration damper of claim 6, wherein the continuous annular spoke is generally, axially centered between the outermost ring and the intermediate ring.

8. The torsional vibration damper of claim 7, wherein the continuous annular spoke has an axial thickness of about 3 mm to about 20 mm.

9. The torsional vibration damper of claim 1, wherein the outermost ring of the monolithic, generally-annular spoke is the outermost surface of the torsional vibration damper and the inertia ring is positioned radially inward thereof concentric to the inner surface of the outermost ring of the hub.

10. The torsional vibration damper of claim 9, wherein the outermost ring defines a belt-engaging surface.

11. The torsional vibration damper of claim 1, wherein the inertia ring defines the outermost surface of the torsional vibration damper.

12. The torsional vibration damper of claim 11, wherein the outermost surface of the torsional vibration damper defines a belt-engaging surface.

13. The torsional vibration damper of claim 1, wherein the second elastomer member is positioned axially between the central hub and the monolithic, generally-annular spoke, and is mold bonded thereto.

14. The torsional vibration damper of claim 13, wherein the inertia ring defines the outermost surface of the torsional vibration damper.

15. The torsional vibration damper of claim 13, wherein the outermost ring of the monolithic, generally-annular spoke is the outermost surface of the torsional vibration damper.

16. The torsional vibration damper of claim 1, wherein the first elastomer member is seated in an annular recess in a surface of the outermost ring of the monolithic, generally-annular spoke, in an annular recess in a surface of the inertia ring, or in an annular recess in each thereof, the annular recesses being concentric about the axis of rotation.

17. The torsional vibration damper of claim 16, wherein both the outermost ring of the monolithic, generally-annular spoke and the inertia ring have the annular recess and one of the annular recesses is deeper than the other.

18. The torsional vibration damper of claim 1, wherein the first elastomer member has a first axial width that is substantially similar to a second axial width of the outermost ring of the monolithic, generally-annular spoke, and is press-fit between the monolithic, generally-annular spoke and the inertia ring or is mold bonded to one of the monolithic, generally-annular spoke or inertia ring.

19. The torsional vibration damper of claim 1, wherein the first elastomer member comprises a plurality of first elastomer members each having a first axial width that is less than a second axial width of the outermost ring of the monolithic, generally-annular spoke and are positioned a distance apart in an axial direction from one another.

20. A front end accessory drive system comprising the torsional vibration damper of claim 1.
